(19) United States
(12) Patent Application Publication
(10) Pub. No.: US 2007/0101275 A1
(43) Pub. Date: May 3, 2007

(54) NETWORK APPLIANCE DEVICE

(76) Inventor: VALERIO DELLA-PORTA, ROYAL OAK, MI (US)

Correspondence Address: ARTZ & ARTZ, P.C., 28333 TELEGRAPH RD., SUITE 250, SOUTHFIELD, MI, 48034, US

(21) Appl. No.: 11/555,340

(22) Filed: Nov. 1, 2006

Related U.S. Application Data
(60) Provisional application No. 60/732,315, filed on Nov. 1, 2005.

(51) Int. Cl. G06F 17/00; G06F 3/00; G06F 9/00

(52) U.S. Cl. 715/747

(57) ABSTRACT

An always-connected network appliance device designed to be the personal processing and storage device for digital assets such as pictures and video streams. The device is also capable of storing other electronic assets such as slide presentations, documents and the like. The network appliance device includes a locked operating system consisting of a software system that runs on a hardware platform. A user uploads desired digital and electronic assets, otherwise known as media, to the network appliance device for storage. As the media is uploaded, a data form is filled out and associated with the media. The media may then be sorted utilizing the data form and may be manipulated by the user within a search results window for easier viewing. The user may also introduce media to viewable trays that may be accessed by one or more additional users based on user preferences.

### CROSS REFERENCE TO RELATED APPLICATION

The present invention claims priority from U.S. Provisional Patent Application Serial No. 60/732,315, filed Nov. 1, 2005, and entitled “Network Appliance Device.”

### TECHNICAL FIELD

The present invention relates generally to an electronic storage device and more specifically to an always-connected network appliance device designed to be the primary storage device for many types of digital assets.

### BACKGROUND OF THE INVENTION

Many years ago, personal computers brought information storage and processing to the individual. As the technology sophistication level has increased, in the form of hardware and software, many different kinds of digital or electronic assets are now capable of being uploaded, run, stored or otherwise manipulated by a user from his home personal computer or remotely through electronically connected devices such as cell phones, digital cameras, laptop computers and the like. These assets include digital assets such as pictures, video streams, slide presentations, generic documents and the like.

The Internet allowed individuals to be connected with each other and to share this stored information. In addition, there are websites that allow the storage of your information. However, the user does not own these websites, and thus the user has no assurances as to the security of these files once uploaded. Moreover, the user may be unsure as to whether others may alter or delete their files after uploading. Also, the user is at the whim of the website owner, in that the website owner may shut down the website at any time or may restrict access to the website such that the user may not be able to retrieve the downloaded files.

### SUMMARY OF THE INVENTION

The present invention is an always-connected network appliance device designed to be the personal processing and storage device for digital assets such as pictures and video streams. The device is also capable of storing other electronic assets such as slide presentations, documents and the like. The network appliance device includes a locked operating system, defined wherein the user cannot administer or install new programs, consisting of a software system that runs on a hardware platform.

The user interacts with the network appliance device by using standard Internet protocols in order to receive a user interface and exchange data. Alternatively, the user can interact with the network appliance device directly through a hard line connection between a personal computer and the network appliance device or by inserting memory devices like flash memory cards into the provided readers .

The user than uploads desired digital and electronic assets, otherwise known as media, to the network appliance device for storage. As the media is uploaded, the user is prompted to fill in one or more data fields with searchable terms on a data form that is associated with the media. The user may then subsequently search the network appliance device utilizing the searchable terms to display any media including those searchable terms. The user within a search results window for easier viewing may manipulate the displayed terms.

The user may also then place any or all of the media within a currently available tray, or create a new tray and include media, and designate a user preference for that tray. Thus, other users may enter the network appliance device and view any trays or media in which they have been granted accessibility.

The present invention thus addresses some of the deficiencies present in the prior art with regards to the storage and viewing of media. The present invention is a personal processing and storage device, yet does not encumber the use of the user's own personal electronic devices such as the personal computer or other communication devices such as laptop computers, cell phones and the like.

Other objects and features of the present invention will become apparent when viewed in light of the detailed description and preferred embodiment when taken in conjunction with the attached drawings and claims.

### BRIEF DESCRIPTION OF THE DRAWINGS

FIG. 1 is a perspective view of an electronic network including the network appliance device in accordance with a preferred embodiment of the present invention;

FIG. 2 is a logic flow diagram for utilizing the network appliance device within the electronic network of FIG. 1;

FIG. 3 illustrates a computer screen shot displaying aspects of the visual display of the network appliance device of FIG. 1 in conjunction with the logic flow diagram of FIG. 2; and

FIG. 4 illustrates a computer screen shot of a data form of the network appliance device of FIG. 1 in conjunction with the logic flow diagram of FIG. 2.

### DESCRIPTION OF PREFERRED EMBODIMENTS

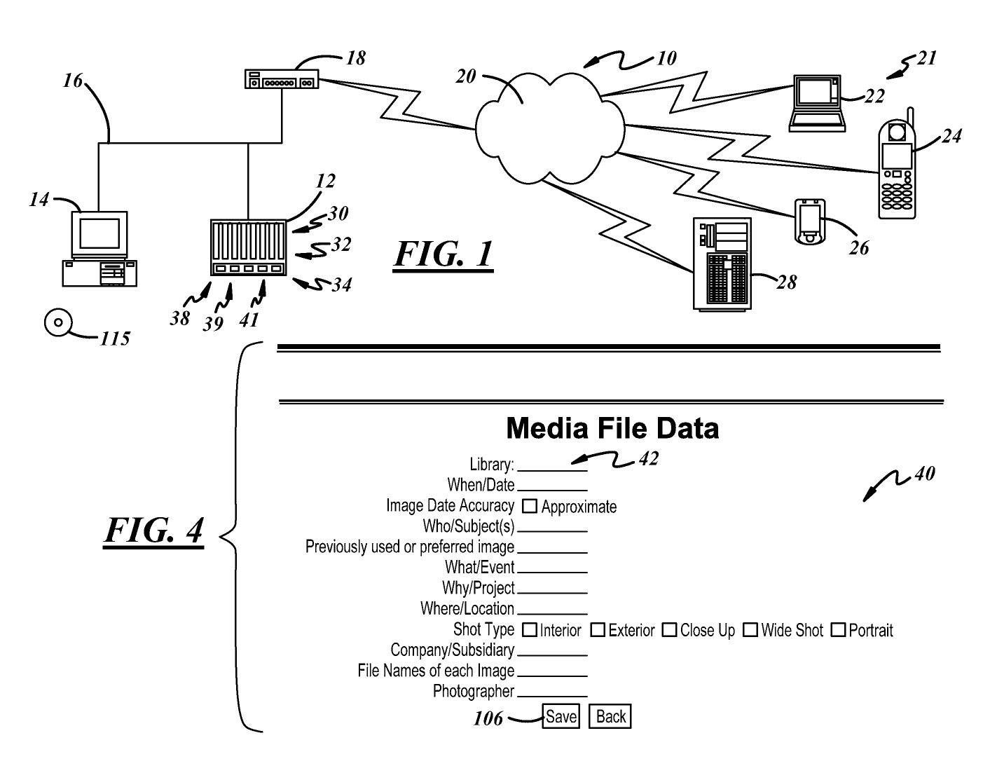

Referring now to FIG. 1, an electronic network 10 is shown in accordance with a preferred embodiment of the present invention.

The electronic network 10 includes a network appliance device 12 that may be electronically coupled to a personal computer (“PC”) 14 through a private LAN line 16. The network appliance device 12 and personal computer 14 are also preferably electronically coupled to an external interface device 18 through the same or additional private LAN lines 16. The external interface device 18 may be selected from any conventional interface device, including but not limited to cable lines, digital subscriber lines (“DSL”), modems or routers.

The network appliance device 12 is also preferably electronically coupled through the external interface device 18 to the internet 20 and further, through the internet 20, may be coupled to various other communication devices 21 including, but not limited to, laptop computers 22, cell phones 24, hand held computers 26 and servers 28. Thus, information can be readily shared between the PC 14, network appliance device 12, and one or more of the communication devices 21.

The network appliance device 12 is designed to be the personal processing and storage device for various digital assets such as pictures and video streams. The device 12 is also capable of processing and storing other types of electronic assets such as slide presentations, documents and the like. The network appliance device 12 includes a locked operating system 30 consisting of a software system 32 that runs on a hardware platform 34. An operating system 30 is considered locked when a user cannot administer or install programs, much like the modern cell phone.

The software system 32 consists of one or more coordinated computer programs 38 that allow a user to upload, store and/or otherwise manipulate media 36 from any communication device 21 or personal computer 14 compatible with the computer programs 38 and hardware platform 34. For the purposes of the present invention, media 36 is defined as a discrete chunk of binary and textual data that can be viewed and/or decoded to represent text and/or images and specifically includes the digital and electronic assets described above. In a personal computer 14, for example, media 36 is commonly known as a file.

The software system 32 also is designed to allow the user to create a data form 40 for categorizing individual media 36. The data forms 40 provide data fields 42 that each provide specific information regarding the media 36, including but not limited to the name, creation date, and other relevant textual data that may be searched for later retrieval. Additional data fields 42 may be added that allow the user to designate preferences whereby additional users are able to view, alter, modify or manipulate the coupled media 36. The data form 40 associated with each individual media 36 may be altered, duplicated, or otherwise manipulated post-creation to allow an individual media 36 to be additionally categorized in any number of different fashions.

The software program 38 also includes a sorting program 39 that allows a user to search one or more keywords and sort the associated media 36, to which he has been given access, accordingly. The sorted media 36 collectively may be separately stored into a tray 44. The trays 44 may also include an additional data form 46 allowing for a description of the included and sorted media 36 and may include additional limitations as to additional user accessibility and preferences. The trays 44 may also be displayed during a search, if the user conducting the search has previously been granted accessibility to the tray 44 and its associated media 36. For the purposes of the present invention, a tray 44, by definition, is a collection of pointers to media.

The network appliance device 12, unlike servers and other electronic storage devices, gives individual users the freedom of owning a secured repository and the convenience of online access and service. The network appliance device 12 to search and retrieve a specific group of media 36 and place them into a tray 44 for subsequent use. The network appliance device 12 also allows the user to modify or otherwise manipulate stored media 36 and resave in a new or altered form.

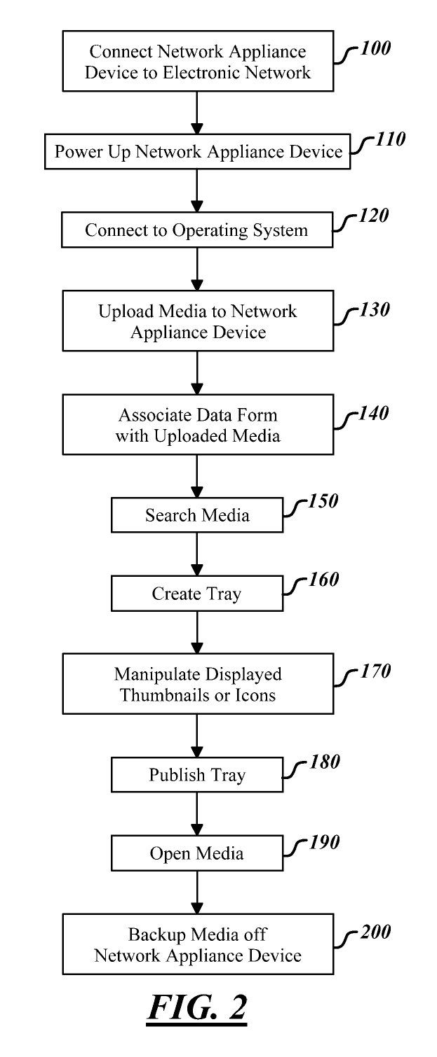

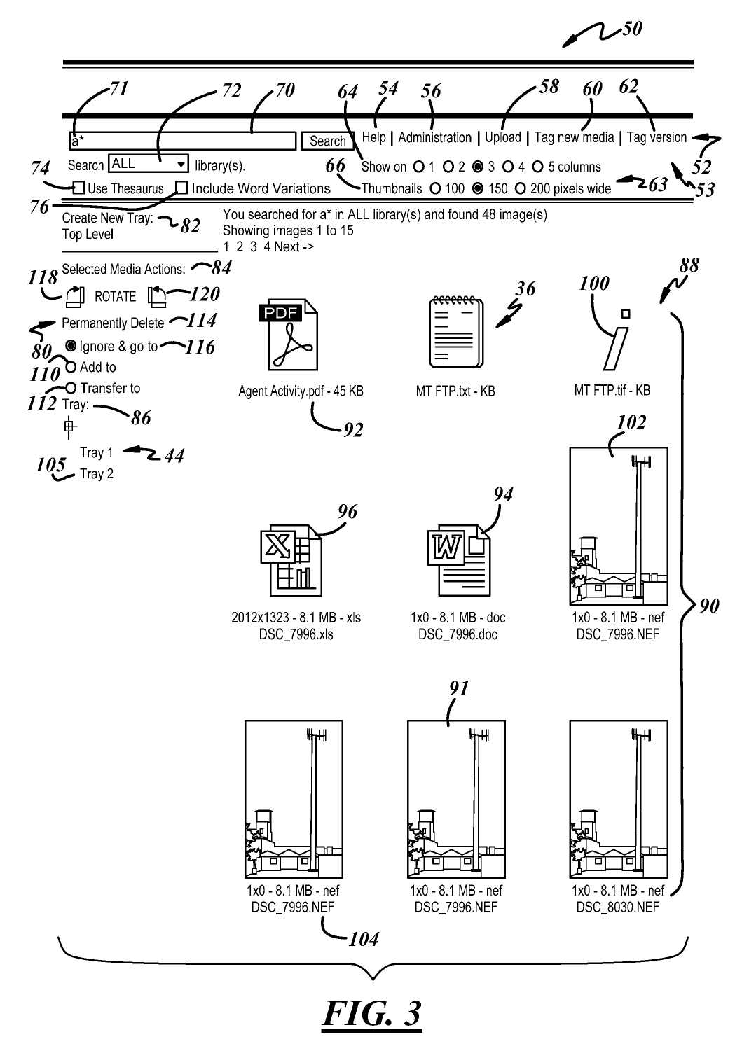

FIG. 2 shows a logic flow diagram for connecting and utilizing the network appliance device 12. FIGS. 3 and 4 illustrate different computer screen shots illustrating various aspects of the visible portion of the displayed page that follows the logic flow diagram of FIG. 2.

Referring first to Step 100, the network appliance device 12 including the locked operating system 30 having the pre-installed software system 32 and hardware platform 34 is connected within the electronic network 10.

Next, as shown in Step 110 of FIG. 2, the user powers up the network appliance device 12. After the device is powered up, the user can connects to it from an Internet browser. A setup screen allows a fixed or dynamic IP address and a fixed or dynamic domain name system (“DNS”), as well as setting a password for accessing the system. The setup screen provides an administrator with a username and password for subsequently entering the operating system 30. After saving the information, and the operating system 30 is ready for use.

Next, in Step 120 of FIG. 2, a user connects to the operating system 30 by typing in the IP address or DNS name, at which point the user is connected to a login screen. The login screen is conventional in design, and may take on many known forms, and typically includes a space to enter a user ID and a password. The user logs in with a username and a proper password, and is connected to the main screen 50 of the network appliance device 12, as shown in FIG. 3.

Referring now to FIG. 3, the main screen 50, in accordance with one preferred embodiment of the present invention, includes a toolbar 52 having a series of menus 53 that provides the user with many choices as to how to proceed. These menus 53 may be pull-down menus and preferably include a help menu 54, an administration menu 56, an upload menu 58, a tag new media menu 60 and a tag version menu 62. Other menus 53 not displayed, but consistent with potential uses for the present application, are specifically contemplated.

Located below the menus 53 are a series of buttons 63 that aid the user in displaying the searched information. For example, a show on button 64 allows search results shown in the search results area 88 to be displayed in any number of columns (shown herein as 1, 2, 3, 4 or 5 columns). Further, a thumbnails button 66 allows the user to select the pixel width of any displayed thumbnails in the search results area (shown here as 100, 150 or 200 pixels in width).

The main screen 50 also includes a search box 70 for entering a search of all available media 36 and trays 44 located on the operating system 30. A secondary search box 72 allows the search to be narrowed to particular libraries of available media 36 and trays 44, and further includes a thesaurus check box 74 and word variation checkbox 76 that aids in narrowing the search feature.

A second toolbar 80 extends down the left side of the main screen 50 that includes additional menus available for the user to utilize. This includes a create a new tray button 82, a selected media actions button 84, and a tray button 86.

The main screen 50 also includes a search results area 88 that displays a search results subset 90 of said media 36 as thumbnails 91, or icons 91, requested by the user. These search results subset 90 can be in many electronic forms, including text files in pdf (“portable document format”) 92, word files 94, excel files 96, tiff file images 100 and the like. In addition, the search results may be in the form of digital photographs thumbnails 102 in many different forms, including, for example, nef files 104 (a file format produced by the Nikon D1 digital camera).

In Step 130 of FIG. 2, the user uploads a particular media 36 by clicking on the upload menu 58. The user is prompted to select the media 36 to be uploaded from either the communication device 21 or personal computer 14 to the operating system 30. The software program 38 includes various additional uploading programs 41 designed to recognize and upload any of the potential kinds of media 36 contained on the communication device 21 or personal computer

Once the desired media 36 is selected and uploaded, as further shown in FIG. 4 and in Step 140 of FIG. 2, the user encounters a data form 40 that is to be associated with the uploaded media 36, as shown in FIG. 5. The user then fills in one or more data fields 42 on the data form 40 that is desired and clicks the save button 106. Examples of data fields 42 that may be utilized include but are not limited to library choice, date, image data accuracy, subject, event, project, location, shot type, company, file name, and photographer. Steps 130 and 140 may be repeated one or more times to create additional media 36.

Next, in Step 150, a user may perform a search for particular media 36 by entering one or more keywords 71, or searchable terms 71, into a search box 70 and additional limitations into the secondary search box 72, thesaurus check box 74 and/or word variation checkbox 76. The software program 38 will then search the available media 36 and display the media 36 containing one or more of the keywords 71 searched as an icon 91. The user may change what how the search result icons or thumbnails 91 are displayed by changing the number of columns on the show on button 64 and/or may change the thumbnail display pixel width by clicking on the thumbnail button 66.

Next, in Step 160, the user may create a tray 44 by clicking on the create a new tray button 82 and naming the newly created tray 105. The newly created tray 105, and other trays 44 associated with a particular user, will appear under the tray button 86.

Next, in Step 170, the user may manipulate the displayed thumbnails or icons 91 as desired. For example, the user may move one or more of the thumbnails or icons 91 into the newly created tray 44 by clicking on the thumbnail or icon 91 and then clicking on the add to button 110, one of the selected media actions buttons 84.

Alternatively, the user may transfer one or more of the thumbnails or icons 91 from one previously created tray 44 to another newly created tray 105 by clicking the transfer to button 112.

Further, the user may delete one or more of the icons or thumbnails 91 by simply right clicking the icon or thumbnail 91 and hitting the delete prompt or may click the permanently delete button 114. The user may also ignore a particular icon or thumbnail 91 by clicking the ignore and go to button 116, which will then remove the icon or icon 91 from the particular search results area 88.

Additionally, the user can open any of the icons or thumbnails 91, therein displaying them in the search results area 88. Next, the user may rotate the displayed media 36 clockwise or counterclockwise by clicking the clockwise or counterclockwise buttons 118,120. This allows the media 36 associated with an icon or thumbnail 91 to be displayed in any number of configurations.

Next, in Step 180, the user may publish the tray 44 or otherwise allow additional users to access the media 36 contained within one or more trays 44 by designating such on the tray 44.

Next, in Step 190, the user may open any media 36 associated with or not associated with a tray 44 and view or manipulate the information and/or data form 40 as desired.

Finally, in Step 200, the user may backup data and media 36 associated with one or more trays 44, onto a storage media device 115 such as a DVD or CD coupled to the personal computer 14 or communication device 21 by simply saving any of the displayed trays 44 or saved media through the prompts contained on the personal computer 14 or communication device 21 that are well known to those of ordinary skill in the art.

The present invention thus provides a user with an always-connected network appliance device designed to be the personal processing and storage device for digital assets such as pictures and video streams. The device is also capable of storing other electronic assets such as slide presentations, documents and the like. The device creates a personal, secure storage device on the Internet that breaks the hierarchical folder paradigm currently utilized for storage. Instead, a user simply creates a data retrieval system, in the form of data forms associated with the various media 36, that allows the media 36 to be easily searched and retrieved.

One preferred application for the present invention is to create a photo album of digital pictures and other documents uploaded from various communication devices such as digital cameras that can subsequently be sorted by category, date, or any other criteria envisioned by the user. The device 12 therein frees up a user's hard drive space on his personal computer 14 or communication device 21 for use in other areas, including creating more pictures or storage and use of other things.

In addition, it is contemplated that the network device 12 can be further expanded to include a user's website, email, calendar and/or blog. In this way, user can control which documents and things are contained on one's personal computer 14 and which are contained on the network device 12, thus allowing the user additional storage on one's personal computer for other documents and things without having the need to upgrade or increase storage capabilities.

While the invention has been described in connection with one or more embodiments, it is to be understood that the specific mechanisms and techniques which have been described are merely illustrative of the principles of the invention, numerous modifications may be made to the methods and apparatus described without departing from the spirit and scope of the invention as defined by the appended claims.

What is claimed is:

1. An electronic network used for storing and organizing electronic and digital media, the network comprising:
a personal computer accessible by a user, said personal computer containing media, wherein media is defined as a discrete chunk of binary or textual data that can be viewed and/or decoded to represent text and/or images by said personal computer; and
a network appliance device electronically coupled to said personal computer, said network appliance device including a locked operating system comprising a software system running on a hardware platform,
wherein said network appliance device is capable of uploading and storing said media by said user from said personal computer and associating a data form with each of said media as said media is upload, said data form including at least one data field containing a search term that allows said media to be categorized by said network appliance device, wherein said media is viewable in substantially the same form as said media on said personal computer.

2. The electronic network of claim 1, wherein said data form may be subsequently altered by said user through said personal computer.

3. The electronic network of claim 1, wherein said software system includes a sorting program that allows a user to enter a search term and search for said search term from said at least one data field of each of said media and display said media having said search term.

4. The electronic network of claim 1, wherein said software system includes one or more computer programs that allow said user to upload, store, and manipulate said media.

5. The electronic network of claim 1, wherein said software system allows said user to create one or more named trays for storing one or more of said media.

6. The electronic network of claim 5, wherein said user may introduce a viewing preference to said tray to allow another user to view said tray when said another user is granted said viewing preference.

7. The electronic network of claim 1, wherein a user may alter said search term in one of said data fields after said media is uploaded to said network appliance device.

8. The electronic network of claim 1, wherein said software system allows said user to copy said media to form a second media and associate a second data form with said second media, wherein said second media is equivalent to said media and is viewed and/or decoded to represent text and/or images by said personal computer.

9. The electronic network of claim 1, further comprising:
an external interface device electronically coupled to said network appliance device; and
one or more communication devices electronically coupled to said external interface device through the internet, each of said one or more communication devices containing another of said media, wherein said user is capable of uploading said another of said media from one of said one or more communication devices to said network appliance device, wherein said another of said media is equivalent to said media and is viewed and/or decoded to represent text and/or images by said personal computer and said one or more communication devices.

10. The electronic network of claim 9, wherein said one or more communications devices is selected from the group consisting of a laptop computer, a cell phone, a hand held computer and a server.

11. The electronic network of claim 9, wherein said external interface device is selected from the group consisting of a cable line, a digital subscriber line, a modem and a router.

12. A method for a user to securing media onto a storage device remote from a personal computer or one or more communication devices in an electronic network, wherein media is defined as a discrete chunk of binary and textual data that can be viewed and/or decoded to represent text and/or images and specifically includes the digital and electronic assets, the method comprising:
electronically coupling a network appliance device to the personal computer or communication device in the electronic network, said network appliance device including a locked operating system comprising a software system running on a hardware platform, said software system including one or more computer programs and a sorting program;
powering up said network appliance device;
uploading the media from said personal computer or said communication device to said network appliance device;
associating a data form having at least one data field with each of the media as the media is upload, and
introducing a searchable term into one of said at least one data fields.

13. The method of claim 12 further comprising:
searching for a desired subset of said media by introducing a desired searchable term into a search box displayed to said user and clicking a search icon displayed to said user, wherein said software system utilizes said sorting program to display a desired subset of said media having said desired searchable term in a search results window.

14. The method of claim 13 further comprising:
creating a tray on said network appliance device by clicking on a create tray icon displayed to said user; and
introducing at least one of said media of said desired subset to said tray.

15. The method of claim 14 further comprising:
associating a user preference to said created tray to allow one or more users to be able to view said tray and said at least one of said media contained in said tray.

16. The method of claim 12 further comprising:
introducing a second searchable term to another one of said at least two data fields, wherein said at least one data field comprises at least two data fields.

17. The method of claim 12 further comprising:
altering at least one of said data fields on one of said data forms by adding, amending or deleting a searchable term to said at least one of said data fields.

18. The method of claim 13 further comprising:
manipulating one or more of said desired subsets displayed within said search window.

19. The method of claim 12, wherein said communication device is electrically coupled to said network appliance device through an external interface device coupled to the Internet.

20. The method of claim 19, wherein said communication device is selected from the group consisting of a laptop computer, a cell phone, a hand held computer and a server and wherein said external interface device is selected from the group consisting of a cable line, a digital subscriber line, a modem and a router.
